(19) United States
(12) Patent Application Publication
(10) Pub. No.: US 2024/0010254 A1
(43) Pub. Date: Jan. 11, 2024

(54) LAWN MOWER DECK CART

(71) Applicant: Dewayne Penna, West Olive, MI (US)

(72) Inventor: Dewayne Penna, West Olive, MI (US)

(21) Appl. No.: 17/857,537

(22) Filed: Jul. 5, 2022

(51) Int. Cl. B62B 1/06

(52) U.S. Cl. CPC B62B 1/06

(57) ABSTRACT

A lawn mower deck cart, including a plurality of rear rods to receive a lawn mower deck thereon, a plurality of front rods disposed a first distance away from the plurality of rear rods to receive the lawn mower deck thereon, such that the lawn mower deck is disposed between the plurality of rear rods and the plurality of front rods, and a plurality of wheels disposed on at least a portion of the rear rods to facilitate movement of the plurality of rear rods and the plurality of front rods while the plurality of wheels are disposed on a planar surface.

### BACKGROUND

### 1. Field

The present general inventive concept relates generally to a cart, and particularly, to a lawn mower deck cart.

### 2. Description of the Related Art

Typically, lawn mowers are big and bulky machines that require a vast amount of space for storage. Moreover, performing maintenance on lawn mowers can be highly difficult due to size and/or weight of the lawn mower.

Additionally, a lawn mower has no ability to change orientation from a horizontal position. In other words, the lawn mower is usually disposed in a parallel plane to a ground during use as well as storage. Unfortunately, changing the orientation of the lawn mower is not feasibly unless the lawn mower is titled against a wall, which can be dangerous.

Therefore, there is a need for a lawn mower deck cart that facilitates storage of a lawn mower deck and can store the lawn mower in multiple positions.

### SUMMARY

The present general inventive concept provides a lawn mower deck cart.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a lawn mower deck cart, including a plurality of rear rods to receive a lawn mower deck thereon, a plurality of front rods disposed a first distance away from the plurality of rear rods to receive the lawn mower deck thereon, such that the lawn mower deck is disposed between the plurality of rear rods and the plurality of front rods, and a plurality of wheels disposed on at least a portion of the rear rods to facilitate movement of the plurality of rear rods and the plurality of front rods while the plurality of wheels are disposed on a planar surface.

The plurality of rear rods may include a first rear rod, and a second rear rod disposed a second distance away from the first rear rod.

The first rear rod may be disposed in parallel with the second rear rod.

The plurality of front rods may include a first front rod, and a second front rod disposed a second distance away from the first front rod.

The first front rod may be disposed in parallel with the second front rod.

The plurality of wheels may facilitate movement in response to tilting the plurality of rear rods and the plurality of front rods at an angle with respect to the planar surface.

The lawn mower deck cart may further include a plurality of base rods disposed between the plurality of rear rods and the plurality of front rods to stabilize the plurality of rear rods and the plurality of front rods in a vertical position with respect to the planar surface.

The lawn mower deck cart may further include a handlebar disposed on at least a portion of the plurality of rear rods to facilitate gripping thereof.

The lawn mower deck cart may further include a plurality of protecting rods disposed between each of the plurality of rear rods and each of the plurality of front rods to absorb an impact from the lawn mower deck thereon.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an isometric top view of a lawn mower deck cart, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Lawn Mower Deck Cart 100
Rear Rods 110
First Rear Rod 111
Second Rear Rod 112
Front Rods 120
First Front Rod 121
Second Front Rod 122
Base Rods 130
First Base Rod 131
Second Base Rod 132
Wheels 140
First Wheel 141
Second Wheel 142
Axle 150
Handlebar 160
Protecting Rods 170

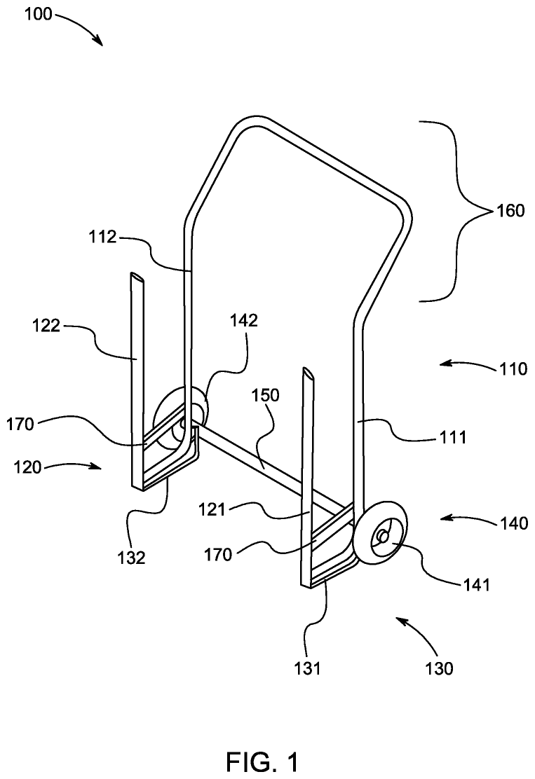

FIG. 1 illustrates an isometric top view of a lawn mower deck cart 100, according to an exemplary embodiment of the present general inventive concept.

The lawn mower deck cart 100 may be constructed from at least one of metal, plastic, wood, and rubber, etc., but is not limited thereto.

The lawn mower deck cart 100 may include a plurality of rear rods 110, a plurality of front rods 120, a plurality of base rods 130, a plurality of wheels 140, an axle 150, a handlebar 160, and a plurality of protecting rods 170, but is not limited thereto.

Referring to FIG. 1, the plurality of rear rods 110, the plurality of front rods 120, the plurality of base rods 130, the handlebar 160, and/or the plurality of protecting rods 170 are illustrated to have a cylindrical shape. However, the plurality of rear rods 110, the plurality of front rods 120, the plurality of base rods 130, the handlebar 160, and/or the plurality of protecting rods 170 may be rectangular, triangular, pentagonal, hexagonal, heptagonal, octagonal, or any other shape known to one of ordinary skill in the art, but is not limited thereto.

The plurality of rear rods 110 may include a first rear rod 111 and a second rear rod 112, but is not limited thereto. Also, each of the plurality of rear rods 110 may be constructed from at least one first tube to connect to at least one second tube. In other words, each of the plurality of rear rods 110 may be a single tube and/or a plurality of interconnected tubes.

The first rear rod 111 may receive at least a portion of a lawn mower deck thereon.

The second rear rod 112 may be disposed in parallel to the first rear rod 111 and disposed a first distance away from the first rear rod 111. Similarly, the second rear rod 112 may receive at least a portion of the lawn mower deck thereon.

The plurality of front rods 120 may include a first front rod 121 and a second front rod 122, but is not limited thereto. Also, each of the plurality of front rods 120 may be constructed from at least one first tube to connect to at least one second tube. In other words, each of the plurality of front rods 120 may be a single tube and/or a plurality of interconnected tubes.

The first front rod 121 may be disposed in parallel to the first rear rod 111 and/or the second rear rod 112, and disposed a second distance away from the first rear rod 111.

The second front rod 122 may be disposed in parallel to the first front rod 121, and disposed the first distance away from the first front rod 121. In other words, the second front rod 122 may be disposed away from the first front rod 121 at the same distance as the second rear rod 112 is disposed away from the first rear rod 111. Also, the first front rod 121 may be disposed away from the first rear rod 111 at another same distance as the second front rod 122 is disposed away from the second rear rod 112.

The plurality of base rods 130 may include a first base rod 131 and a second base rod 132, but is not limited thereto. Also, each of the plurality of base rods 130 may be constructed from at least one first tube to connect to at least one second tube. In other words, each of the plurality of base rods 130 may be a single tube and/or a plurality of interconnected tubes.

The first base rod 131 may be perpendicularly disposed at a first end away from a first end of the first rear rod 111 and/or perpendicularly disposed at a second end away from a first end of the first front rod 121. In other words, the first base rod 131 may connect the first rear rod 111 to the first front rod 121, such that the first base rod 131 may be disposed between the first rear rod 111 and/or the first front rod 121. Furthermore, a length of the first base rod 131 may be equivalent to a distance of the first front rod 121 disposed away from the first rear rod 111.

The second base rod 132 may be perpendicularly disposed at a first end away from a first end of the second rear rod 112 and/or perpendicularly disposed at a second end away from a first end of the second front rod 122. In other words, the second base rod 132 may connect the second rear rod 112 to the second front rod 122, such that the second base rod 132 may be disposed between the second rear rod 112 and/or the second front rod 122. Furthermore, a length of the second base rod 132 may be equivalent to a distance of the second front rod 122 disposed away from the second rear rod 112.

Collectively, and/or individually, the first base rod 131 and/or the second base rod 132 may orient the plurality of rear rods 110 and/or the plurality of front rods 120 in a vertical direction in response to the first base rod 131 and/or the second base rod 132 being disposed on a planar surface, such as a ground surface, a table, a countertop, etc. Also, the first base rod 131 and/or the second base rod 132 may stabilize the plurality of rear rods 110 and/or the plurality of front rods 120 while the plurality of base rods 130 are fully disposed (e.g., an entire length of each of the plurality of base rods 130 is in contact) on the planar surface.

The plurality of wheels 140 may include a first wheel 141 and a second wheel 142, but is not limited thereto.

The first wheel 141 may be movably (i.e., rotatably) disposed on at least a portion of the first rear rod 111 and/or the first base rod 131. The second wheel 142 may be movably (i.e., rotatably) disposed on at least a portion of the second rear rod 112 and/or the second base rod 132. The first wheel 141 and/or the second wheel 142 may facilitate movement of the plurality of rear rods 110, the plurality of front rods 120, and/or the plurality of base rods 130 in response to rotating. Additionally, the first wheel 141 and/or the second wheel 142 may move in response to an application of force (e.g., pushing, pulling) against the plurality of rear rods 110, the plurality of front rods 120, and/or the plurality of base rods 130 while the plurality of rear rods 110, the plurality of front rods 120, and/or the plurality of base rods 130 are tilted at an angle with respect to the planar surface, such that only the first wheel 141 and/or the second wheel 142 contact the planar surface and/or the plurality of base rods 130 are not in contact with the planar surface.

The axle 150 may connect the first wheel 141 to the second wheel 142. Accordingly, the first wheel 141 and/or the second wheel 142 may move simultaneously.

The handlebar 160 may be disposed on at least a portion of the first rear rod 111 and/or the second rear rod 112. Moreover, the handlebar 160 may be angularly disposed away from the first rear rod 111 and/or the second rear rod 112. The handlebar 160 may facilitate gripping thereof.

Each of the plurality of protecting rods 170 may include a cushion and/or foam, but is not limited thereto.

Each of the plurality of protecting rods 170 may be disposed between the first rear rod 111 and/or the first front rod 121, and disposed between the second rear rod 112 and/or the second front rod 122. The plurality of protecting rods 170 may absorb an impact thereon, such that the plurality of protecting rods 170 may prevent damage to the lawn mower deck disposed therein.

During use, the plurality of rear rods 110 and/or the plurality of front rods 120 may receive the lawn mower deck therebetween. As such, the plurality of rear rods 110 and/or the plurality of front rods 120 may store the lawn mower deck and improve storage space. The plurality of rear rods 110 and/or the plurality of front rods 120 may be moved to a lateral position (e.g., in parallel with the planar surface) to facilitate moving the lawn mower deck therebetween. Subsequently, the handlebar 160 may be moved to a vertical position, such that the plurality of rear rods 110 and/or the plurality of front rods 120 may be perpendicular to the planar surface to reduce storage space.

Therefore, the lawn mower deck cart 100 may facilitate storage by reducing spaced used by the lawn mower deck. Also, the lawn mower deck cart 100 may improve the ability to provide maintenance by exposing all sides of the lawn mower deck in the vertical position.

The present general inventive concept may include a lawn mower deck cart 100, including a plurality of rear rods 110 to receive a lawn mower deck thereon, a plurality of front rods 120 disposed a first distance away from the plurality of rear rods 110 to receive the lawn mower deck thereon, such that the lawn mower deck is disposed between the plurality of rear rods 110 and the plurality of front rods 120, and a plurality of wheels 140 disposed on at least a portion of the rear rods 110 to facilitate movement of the plurality of rear rods 110 and the plurality of front rods 120 while the plurality of wheels 140 are disposed on a planar surface.

The plurality of rear rods 110 may include a first rear rod 111, and a second rear rod 112 disposed a second distance away from the first rear rod 111.

The first rear rod 111 may be disposed in parallel with the second rear rod 112.

The plurality of front rods 120 may include a first front rod 121, and a second front rod 122 disposed a second distance away from the first front rod 121.

The first front rod 121 may be disposed in parallel with the second front rod 122.

The plurality of wheels 140 may facilitate movement in response to tilting the plurality of rear rods 110 and the plurality of front rods 120 at an angle with respect to the planar surface.

The lawn mower deck cart 100 may further include a plurality of base rods 130 disposed between the plurality of rear rods 110 and the plurality of front rods 120 to stabilize the plurality of rear rods 110 and the plurality of front rods 120 in a vertical position with respect to the planar surface.

The lawn mower deck cart 100 may further include a handlebar 160 disposed on at least a portion of the plurality of rear rods 110 to facilitate gripping thereof.

The lawn mower deck cart 100 may further include a plurality of protecting rods 170 disposed between each of the plurality of rear rods 110 and each of the plurality of front rods 120 to absorb an impact from the lawn mower deck thereon.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A lawn mower deck cart, comprising:
a plurality of rear rods to receive a lawn mower deck thereon;
a plurality of front rods disposed a first distance away from the plurality of rear rods to receive the lawn mower deck thereon, such that the lawn mower deck is disposed between the plurality of rear rods and the plurality of front rods; and
a plurality of wheels disposed on at least a portion of the rear rods to facilitate movement of the plurality of rear rods and the plurality of front rods while the plurality of wheels are disposed on a planar surface.

2. The lawn mower deck cart of claim 1, wherein the plurality of rear rods comprises:
a first rear rod; and
a second rear rod disposed a second distance away from the first rear rod.

3. The lawn mower deck cart of claim 2, wherein the first rear rod is disposed in parallel with the second rear rod.

4. The lawn mower deck cart of claim 1, wherein the plurality of front rods comprises:
a first front rod; and
a second front rod disposed a second distance away from the first front rod.

5. The lawn mower deck cart of claim 4, wherein the first front rod is disposed in parallel with the second front rod.

6. The lawn mower deck cart of claim 1, wherein the plurality of wheels facilitate movement in response to tilting the plurality of rear rods and the plurality of front rods at an angle with respect to the planar surface.

7. The lawn mower deck cart of claim 1, further comprising:
a plurality of base rods disposed between the plurality of rear rods and the plurality of front rods to stabilize the plurality of rear rods and the plurality of front rods in a vertical position with respect to the planar surface.

8. The lawn mower deck cart of claim 1, further comprising:
a handlebar disposed on at least a portion of the plurality of rear rods to facilitate gripping thereof.

9. The lawn mower deck cart of claim 1, further comprising:
a plurality of protecting rods disposed between each of the plurality of rear rods and each of the plurality of front rods to absorb an impact from the lawn mower deck thereon.
